(19) United States
(12) Patent Application Publication
(10) Pub. No.: US 2008/0256608 A1
(43) Pub. Date: Oct. 16, 2008

(54) Linking Between Internet Subscription Websites

(75) Inventors: David Gottlieb, Scottsdale, AZ (US); Donald L. Goguen, Fountain Hills, AZ (US); Bodine Rye Blodgett, Phoenix, AZ (US)

Correspondence Address: Kenneth P. Waszkiewicz;Attorney at Law, 29 Murray Avenue, Annapolis, MD, 21401, US

(73) Assignee: CITATION TECHNOLOGIES, INC., Aliso Viejo, CA (US)

(21) Appl. No.: 11/967,826

(22) Filed: Dec. 31, 2007

Related U.S. Application Data
(60) Provisional application No. 60/877,632, filed on Dec. 29, 2006.

(51) Int. Cl. G06F 21/00

(52) U.S. Cl. 726/4

(57) ABSTRACT

A method and system for managing delivery of a web resource to a user on a web server. The method determines the identity of the user on the web server and retrieves the web resource from the web server. The method scans the web resource to identify links, such as hypertext links, in the web resource that refer to a target web resource. For each link, the method determines whether access is allowed or denied by the user to the target web resource. The method creates a copy of the web resource and deactivates each link in the copy of the web resource if access is denied by the user to the target web resource referred to by the link. The method then delivers the copy of the web resource to the user on the web server.

### CROSS-REFERENCE TO A RELATED APPLICATION

This application for letters patent is related to, and incorporates by reference, U.S. Provisional Patent Application Ser. No. 60/877,632, titled “Linking Between Internet Subscription Websites”, and filed on Dec. 29, 2006.

### BACKGROUND OF THE INVENTION

1. Field of the Invention

The present invention relates, in general, to content and document management and delivery in a computing system. In particular, the present invention is a method and computing system for managing delivery of a web resource to a user on a web server when the web resource includes links to target web resources on a target web server which controls access to a subscription website.

2. Description of the Related Art

The number of documents available on the Internet has risen rapidly since its inception. Taking advantage of protocols such as hypertext linking in the HTML language, many of these documents link to other documents. Frequently, these links are from one document on a website to another document on the same website. It is not uncommon, however, for documents on one website to link to documents on a different website.

A problem arises when one or both websites are restricted to “registered” users, normally those who pay a fee for the privilege of accessing the website. This type of website is often termed a “subscription website”. Consider the case of document XYZ on subscription website A. Within document XYZ is a hypertext link to document UVW, which is not present on website A, but rather is on another subscription website, website B. If the link to document UVW is active in website A, but the user does not have the privilege or authorization to access document UVW on website B, then the user will not ultimately be able to view document UVW. Thus, the link to document UVW in the original document, document XYZ, is futile—it causes the user to expend time and effort without positive result.

On the other hand, deactivating the link to document UVW in document XYZ because we do not know if the user has access rights or not is also unsatisfactory. If the link is deactivated and the user does have access rights, deactivation of the link would deprive the user of the ability to directly make that link.

Thus, there is a demand for managing delivery of a web resource to a user on a web server by deactivating links to target web resources on a subscription website that the user does not have the privilege or authorization to access. Likewise, there is a demand to ensure that links to target web resources on a subscription website that the user has the privilege or authorization to access remain active. The presently disclosed method and system satisfies these demands.

### SUMMARY OF THE INVENTION

A method and system for managing delivery of a web resource to a user on a web server. The method determines the identity of the user on the web server and retrieves the web resource from the web server. The method scans the web resource to identify links, such as hypertext links, in the web resource that refer to a target web resource. For each link, the method determines whether access is allowed or denied by the user to the target web resource. The method creates a copy of the web resource and deactivates each link in the copy of the web resource if access is denied by the user to the target web resource referred to by the link. The method then delivers the copy of the web resource to the user on the web server.

To identify the links, the method scans the web resource and, for each link, obtains a link string, and a location of the link string in the web resource. The method associates this link data with the identity of the user.

When the web server controls access to the target web resource, access is allowed by the user to the target web resource because the identity for the user authorizes the user to retrieve a target web resource. When a target web server controls access to the target web resource and the target web server is related to the web server, to determine whether access is allowed or denied, the method determines whether the identity for the user allows the web server to confirm that the user is authorized to retrieve the target web resource. When a target web server controls access to the target web resource and the target web server is not related to the web server, to determine whether access is allowed or denied, the method sends a query to the target web site to determine whether the identity for the user authorizes the user to access the target web resource, and receives a response to the query indicating whether access to the target web resource by the user is allowed or denied.

### BRIEF DESCRIPTION OF THE DRAWINGS

FIG. 1 is a network diagram that illustrates the hardware components comprising an exemplary embodiment of the system and method for managing delivery of a web resource to a user on a web server.

FIG. 2 is a block diagram that illustrates an exemplary embodiment of the hardware and software components comprising the source web server 110 shown in FIG. 1.

FIG. 3 is a block diagram that illustrates an exemplary embodiment of the hardware and software components comprising the target web server 120 shown in FIG. 1.

FIG. 4 is a flow diagram that illustrates an overview of an exemplary embodiment of the system and method for managing delivery of a web resource to a user on a web server.

FIG. 5 is a flow chart illustrating, in greater detail, the method shown in FIG. 4.

### DETAILED DESCRIPTION OF THE INVENTION

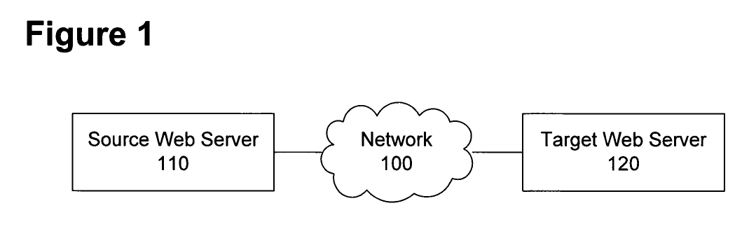

FIG. 1 is a network diagram that illustrates the hardware components comprising an exemplary embodiment of the system and method for managing delivery of a web resource to a user on a web server. The hardware components include a source web server 110 and a target web server 120 that communicate via a network 100.

The network 100 shown in FIG. 1, in an exemplary embodiment, is a public communication network that connects and enables data transfer between the source web server 110 and target web server 120 but, the system and method for managing delivery of a web resource to a user on a web server also contemplates the use of comparable network architectures. Comparable network architectures include the Public Switched Telephone Network (PSTN), a public packet-switched network carrying data and voice packets, a wireless network, and a private network. A wireless network includes a cellular network (e.g., a Time Division Multiple Access (TDMA) or Code Division Multiple Access (CDMA) network), a satellite network, and a wireless Local Area Network (LAN) (e.g., a wireless fidelity (Wi-Fi) network). A private network includes a LAN, a Personal Area Network (PAN) such as a Bluetooth network, a wireless LAN, a Virtual Private Network (VPN), an intranet, or an extranet. An intranet is a private communication network that provides an organization such as a corporation, with a secure means for trusted members of the organization to access the resources on the organization's network. In contrast, an extranet is a private communication network that provides an organization, such as a corporation, with a secure means for the organization to authorize non-members of the organization to access certain resources on the organization's network. The system also contemplates network architectures and protocols such as Ethernet, Token Ring, Systems Network Architecture, Internet Protocol, Transmission Control Protocol, User Datagram Protocol, Asynchronous Transfer Mode, and proprietary network protocols comparable to the Internet Protocol.

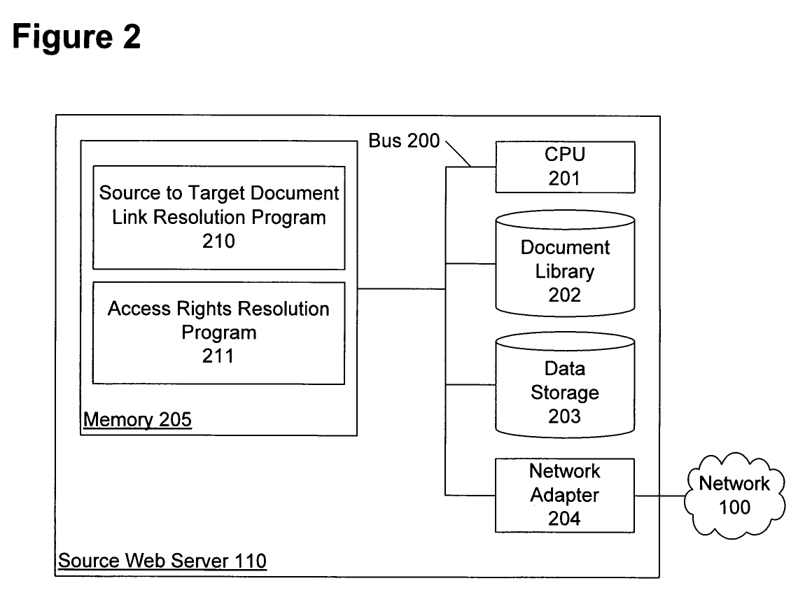

FIG. 2 is a block diagram that illustrates an exemplary embodiment of the hardware and software components comprising the source web server 110 shown in FIG. 1. The source web server 110 is a general-purpose computer. Bus 200 is a communication medium that connects a central processor unit (CPU) 201, document library 202, data storage 203, network adapter 204, and memory 205. The network adapter 204 also connects to the communications network 100 and is the mechanism that facilitates the passage of network traffic between the source web server 110 and the network 100. The CPU 201 performs the disclosed methods by executing the sequences of operational instructions that comprise each computer program resident in, or operative on, the memory 205.

In one embodiment, the configuration of the memory 205 includes a source to target document link resolution program 210, and access rights resolution program 211. These computer programs store intermediate results in the memory 205 and transmit final results via the bus 200 for storage in the document library 202 or data storage 203. It is to be understood that in another embodiment, the configuration of the memory 205 may not simultaneously include these programs. Operating system software resident in a memory of the source web server 110 send instructions to the CPU 201 to coordinate loading a program when it is needed, storing intermediate results, transferring data from one program to another, and unloading the program when it is no longer needed.

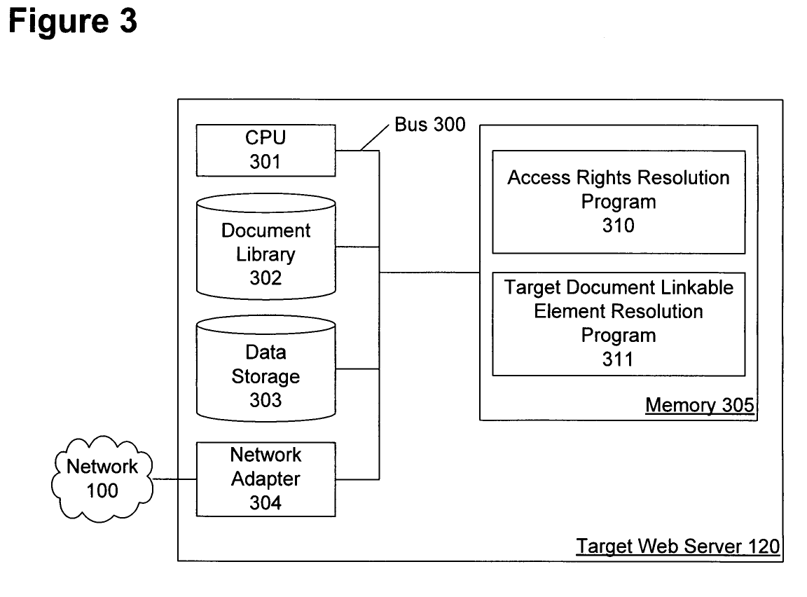

FIG. 3 is a block diagram that illustrates an exemplary embodiment of the hardware and software components comprising the target web server 120 shown in FIG. 1. The target web server 120 is a general-purpose computer. Bus 300 is a communication medium that connects a central processor unit (CPU) 301, document library 302, data storage 303, network adapter 304, and memory 305. The network adapter 304 also connects to the communications network 100 and is the mechanism that facilitates the passage of network traffic between the target web server 120 and the network 100. The CPU 301 performs the disclosed methods by executing the sequences of operational instructions that comprise each computer program resident in, or operative on, the memory 305.

In one embodiment, the configuration of the memory 305 includes an access rights resolution program 310, and target document linkable element resolution program 311. These computer programs store intermediate results in the memory 305 and transmit final results via the bus 300 for storage in the document library 302 or data storage 303. It is to be understood that in another embodiment, the configuration of the memory 305 may not simultaneously include these programs. Operating system software resident in a memory of the target web server 120 send instructions to the CPU 301 to coordinate loading a program when it is needed, storing intermediate results, transferring data from one program to another, and unloading the program when it is no longer needed.

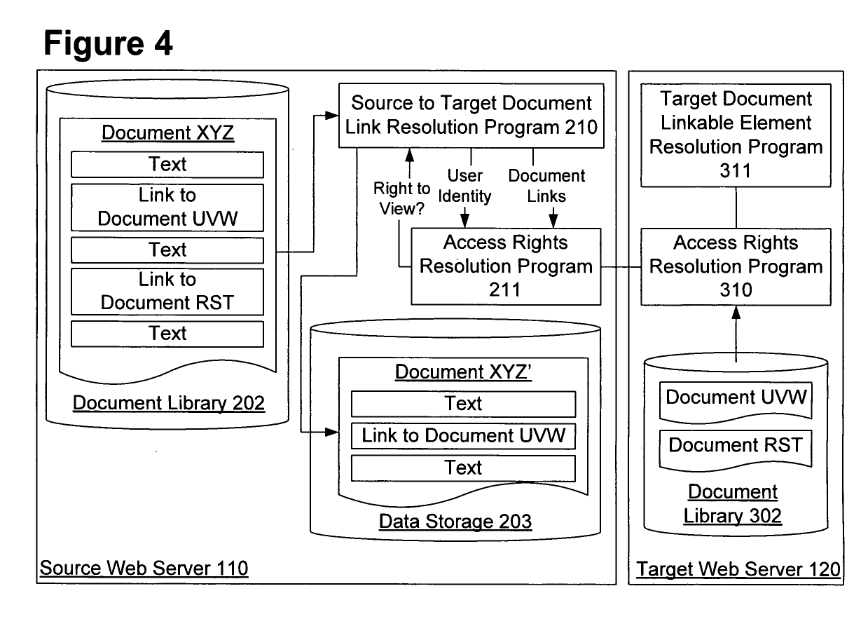

FIG. 4 is a flow diagram that illustrates an overview of an exemplary embodiment of the system and method for managing delivery of a web resource to a user on a web server. As shown in FIG. 4, the method activates links, such as hypertext links, in a document on the source web server 110 that link to a document on the target web server 120, a subscription website, if and only if the person viewing the document on the source web server 110 (i.e., the “user”) has the right to view the document on the target web server 120.

The system of FIG. 4 presumes that the user has accessed the source web server 110 by logging on to it, thereby establishing the user's identity. The user then requests the source web server 110 to display a document (Document XYZ). The source to target document link resolution program 210, which is responsible for obtaining documents from the document library 202 on the source web server 110, responds by retrieving Document XYZ from the document library 202. The source to target document link resolution program 210 also identifies each link in Document XYZ (as shown in FIG. 4, the links to Document UVW and Document RST stored on the document library 302 on the target web server 120). The source to target document link resolution program 210 then invokes the access rights resolution program 211 on the source web server 110, passing to it the user's identity and the identity of the document on the target web server 120, Document UVW or Document RST, to which the potential link refers. The access rights resolution program 211 on the source web server 110 communicates the user's identity and the identity of the document on the target web server 120 with the access rights resolution program 310 on the target web server 120. The access rights resolution program 310 on the target web server 120 invokes the target document linkable element resolution program 311 to determine if the user has access to the requested document on the target web server 120, and returns a “yes” or “no” answer to the source to target document link resolution program 210. If the target document linkable element resolution program 311 returns a “yes”, the source to target document link resolution program 210 activates the link in Document XYZ. If the target document linkable element resolution program 311 returns a “no”, the source to target document link resolution program 210 removes the link from Document XYZ. The source to target document link resolution program 210 stores the resultant document (Document XYZ′) on the data storage 203 for the source web server 110. Document XYZ′ contains active links to documents, such as Document UVW, to which the user has access privileges, and removes the links to document, such as Document RST, to which the user does not have access.

FIG. 4 illustrates an overview of the method of the present invention for connecting two sets of structured documents. The document library 202 on the source web server 110 contains one or more structured documents (one is shown in FIG. 4) that include hypertext links to documents on the document library 302 on the target web server 120. The document library 302 on the target web server 120 also contains one or more structured documents (two are shown in FIG. 4). The source document library 202 and target document library 302 are distinct from one other in the sense that they are not both controlled by the same owner. Therefore, without the connection provided by the method of present invention, there would only be one-way connectivity (from the source document library 202 to the target document library 302). The owner of the target document library 302 would be unaware of the nature and structure of the documents in the source document library 202.

The connectivity provided by the invention requires three computer processes. The source to target document link resolution program 210 (Process A) is logically connected to the source document library 202, and is usually provided by its owner. It is aware of all of the links from the source documents to the target documents, and is capable of providing this information to the access rights resolution program 211.

The target document linkable element resolution program 311 (Process B) is logically connected to the target document library 302 and the target web server 120 and is normally provided by its owner. It is aware of all locations in the target documents to which links may go (“linkable elements”). Further, the target document linkable element resolution program 311 is aware of changes and additions to the target documents. It is capable of providing this information to the access rights resolution program 310 on the target web server 120.

The access rights resolution program 211 on the source web server 110 communicates with the access rights resolution program 310 on the target web server 120. These programs connect the source document links (from the source to target document link resolution program 210) to the linkable elements in the target documents and to the changes in the target documents (from the target document linkable element resolution program 311). These programs are capable of providing feedback to the owner of the source document set, specifically information about changes in the target documents that affect the source documents, as implied by the links from the source documents to the target documents.

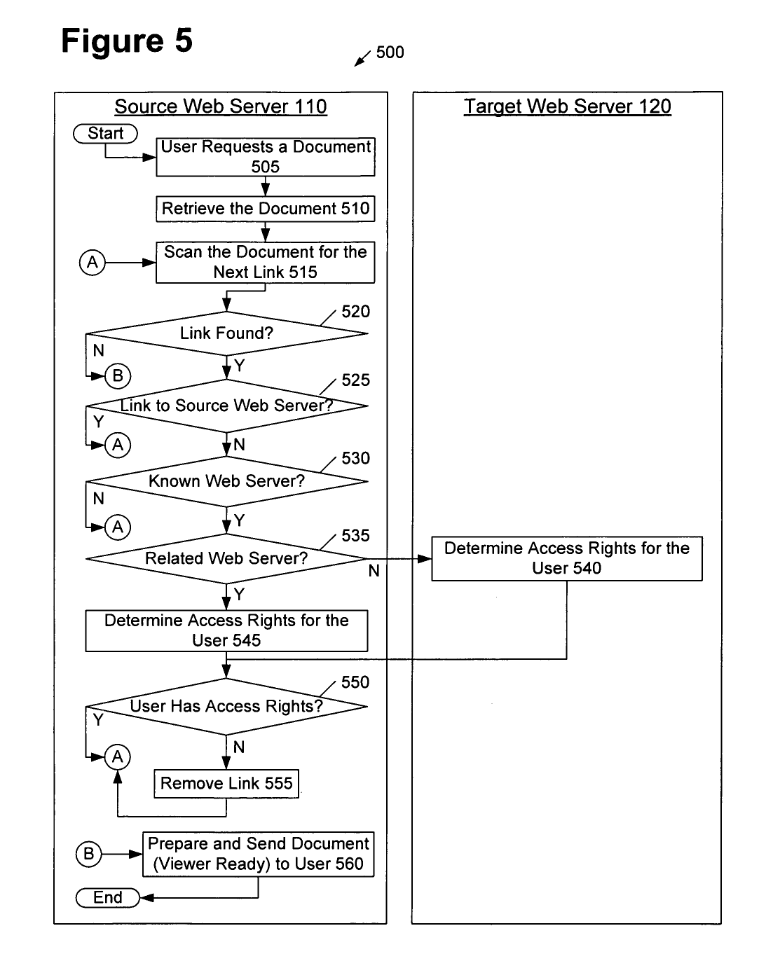

FIG. 5 is a flow chart illustrating, in greater detail, the method shown in FIG. 4. The source web server 110 initiates the process 500 shown in FIG. 5 by a user requesting a document, such as Document XYZ stored in document library 202, to display on a web browser (step 505). The user's identity and the document identifier are passed to the source to target document link resolution program 210 to retrieve the requested document (step 510). This may be done by reading a file, querying a database, or other means.

The source to target document link resolution program 210 begins, at step 515, by scanning through the document until it finds a hypertext link. If the requested document does not include any hypertext links (step 520, N branch), the process 500 prepares the requested document as necessary and sends it to the user's web browser (step 560).

If the requested document includes hypertext links (step 520, Y branch), the process 500 examines the current hypertext link to determine whether the link should be deactivated. The source to target document link resolution program 210 determines, at step 525, whether the link is to a document on the source web server 110. If the link is to a document on the source web server 110 (step 525, Y branch), the link is valid and the source to target document link resolution program 210 takes no further action and returns to step 515 to examine the next hypertext link. If the link is not to a document on the source web server 110 (step 525, N branch), the source to target document link resolution program 210 determines, at step 530, whether the link is to a document on a known web server, that is, a website for which the source to target document link resolution program 210 can determine the access rights for the user. If the link is to a document on an unknown web server (step 530, N branch), the source to target document link resolution program 210 cannot determine the validity of the link so the link is left active and the source to target document link resolution program 210 returns to step 515 to examine the next hypertext link. If the link is to a document on a known web server (step 530, Y branch), the source to target document link resolution program 210 determines, at step 535, whether the link is to a related web server, that is, a website that the source to target document link resolution program 210 can communicate with to determine the access rights for the user. If the link is to a related website (step 535, Y branch), the source to target document link resolution program 210 determines the access rights for the user (step 545) either by a logical algorithm or by querying a database. If the link is not to a related website (step 535, N branch), the source to target document link resolution sends a query to the target web server 120 to determine the access rights for the user (step 540). The query is accomplished via the communication between the access rights resolution program 211 on the source web server 110 and the access rights resolution program 310 on the target web server. Once the source to target document link resolution program 210 obtains the access rights for the user (either via step 540 or step 545), the source to target document link resolution program 210 determines whether the user has the right to access the linked document (step 550). If the user does not have the right to access the linked document (step 550, N branch), the source to target document link resolution program 210 deactivates the link and returns to step 515 to examine the next hypertext link. If the user has the right to access the linked document (step 550, Y branch), the link is valid and the source to target document link resolution program 210 takes no further action and returns to step 515 to examine the next hypertext link.

As illustrated in FIG. 4 and FIG. 5, when a document in a website, such as the document in the source web server 110, includes a potential link to one of the shown documents, one of three outcomes can occur. First, the potential link to which the user does not have access rights is transformed by the source to target document link resolution program 210 to non-linked text, hence there is no possibility of a link. Second, if the linked to document is available in the source web server 110, whether it is also available in the target web server 120 or not, clicking the link will cause the linked to document to be displayed in the source web server 110. Third, if the document is only in the target web server 120, control will be passed to the target web server 120 which displays the linked to document. This process is important if the source web server 110 and target web server 120 have a different look and feel, or enable different processing capabilities, such as different navigational techniques.

Although the disclosed exemplary embodiments describe a fully functioning system and method for managing delivery of a web resource to a user on a web server, the reader should understand that other equivalent exemplary embodiments exist. Since numerous modifications and variations will occur to those reviewing this disclosure, the system and method for managing delivery of a web resource to a user on a web server is not limited to the exact construction and operation illustrated and disclosed. Accordingly, this disclosure intends all suitable modifications and equivalents to fall within the scope of the claims.

We claim:

1. A method for managing delivery of a web resource to a user on a web server, comprising:
determining the identity of the user on the web server;
retrieving the web resource from the web server;
identifying at least one link in the web resource, each link referring to a target web resource;
determining whether access is allowed or denied by the user to the target web resource referred to by each link;
creating a copy of the web resource;
deactivating each link in the copy of the web resource if access is denied by the user to the target web resource referred to by the link; and
delivering the copy of the web resource to the user on the web server.

2. The method of claim 1, wherein the determining of the identity further comprises:
authenticating the user on the web server.

3. The method of claim 1, wherein the web resource and the target web resource include an electronic document, a digital image, a service, web content, or the like.

4. The method of claim 1, wherein the retrieving of the web resource further comprises:
sending a request to the web server for the web resource; and
receiving the web resource in response to the request.

5. The method of claim 1, wherein said at least one link comprises an HTML hypertext link, or the like.

6. The method of claim 1, wherein the identifying of said at least one link further comprises:
scanning the web resource to locate said at least one link;
obtaining link data for each said at least one link, the link data comprising a link string, a location of the link string in the web resource, and the identity of the user; and
storing the link data for each said at least one link.

7. The method of claim 1, wherein access is allowed by the user to the target web resource when the identity for the user authorizes the user to retrieve a target web resource.

8. The method of claim 1, wherein when a target web server controls access to the target web resource, the determining of whether access is allowed or denied further comprises:
determining that the target web server is related to the web server; and
determining whether the identity for the user allows the web server to confirm that the user is authorized to retrieve the target web resource.

9. The method of claim 1, wherein when a target web server controls access to the target web resource, the determining of whether access is allowed or denied further comprises:
sending a query to the target web site to determine whether the identity for the user authorizes the user to access the target web resource; and
receiving a response to the query indicating whether access to the target web resource by the user is allowed or denied.

10. The method of claim 1, wherein the deactivating of each link further comprises:
removing a portion of each link that refers to the target web resource.

11. A method for managing delivery of a web resource to a user on a web server, the web resource including at least one link, each link referring to a target web resource on a target web server, comprising:
receiving an access rights request;
determining whether access is allowed or denied by the user to the target web resource; and
sending a response to the access rights request indicating whether access to the target web resource by the user is allowed or denied.

12. The method of claim 11, wherein the web resource and the target resource include an electronic document, a digital image, a service, web content, or the like.

13. The method of claim 11, wherein the access rights request includes an identity for the user, and an address for the target web resource.

14. The method of claim 11, wherein the determining of whether access is allowed or denied further comprises:
determining whether an identity for the user authorizes the user to access the target web resource.

15. A system for managing delivery of a web resource to a user on a web server, comprising:
a memory device resident in the web server;
a processor disposed in communication with the memory device, the processor configured to:
determine the identity of the user on the web server;
retrieve the web resource from the web server;
identify at least one link in the web resource, each link referring to a target web resource;
determine whether access is allowed or denied by the user to the target web resource referred to by each link;
create a copy of the web resource;
deactivate each link in the copy of the web resource if access is denied by the user to the target web resource referred to by the link; and
deliver the copy of the web resource to the user on the web server.

16. The system of claim 15, wherein to determine the identity, the processor is further configured to:
authenticate the user on the web server.

17. The system of claim 15, wherein to retrieve the web resource, the processor is further configured to:
send a request to the web server for the web resource; and
receive the web resource in response to the request.

18. The system of claim 15, wherein to identify said at least one link, the processor is further configured to:
scan the web resource to locate said at least one link;
obtain link data for each said at least one link, the link data comprising a link string, a location of the link string in the web resource, and the identity of the user; and
store the link data for each said at least one link.

19. The system of claim 15, wherein when a target web server controls access to the target web resource, to determine whether access is allowed or denied, the processor is further configured to:
determine that the target web server is related to the web server; and
determine whether the identity for the user allows the web server to confirm that the user is authorized to retrieve the target web resource.

20. The system of claim 15, wherein when a target web server controls access to the target web resource, to determine whether access is allowed or denied, the processor is further configured to:
send a query to the target web site to determine whether the identity for the user authorizes the user to access the target web resource; and
receive a response to the query indicating whether access to the target web resource by the user is allowed or denied.

21. The system of claim 15, wherein to deactivate each link, the processor is further configured to:
remove a portion of each link that refers to the target web resource.
